(19) United States
(12) Patent Application Publication
(10) Pub. No.: US 2015/0380739 A1
(43) Pub. Date: Dec. 31, 2015

(54) NEGATIVE ELECTRODE PLATE FOR NONAQUEOUS ELECTROLYTE SECONDARY BATTERY AND METHOD OF PRODUCING THE SAME

(71) Applicant: Panasonic Corporation, Osaka (JP)

(72) Inventors: KOZO WATANABE, Osaka (JP); ISAO FUJIWARA, Osaka (JP); NOBUHIRO HIRANO, Osaka (JP)

(21) Appl. No.: 14/736,578

(22) Filed: Jun. 11, 2015

(30) Foreign Application Priority Data
Jun. 30, 2014 (JP) 2014-135248

(51) Int. Cl. H01M 4/62; H01M 4/66; H01M 4/04

(52) U.S. Cl. CPC H01M 4/622; H01M 4/0404; H01M 4/661; H01M 2004/027

(57) ABSTRACT

A negative electrode plate according to an embodiment of the present disclosure includes a negative electrode collector and a negative electrode mixture layer disposed on the negative electrode collector. The negative electrode mixture layer contains a negative active material, a first binding material having a Tg of 10° C. to 60° C., and a second binding material having a Tg of 0° C. or less. When the negative electrode mixture layer is divided into two equal parts at the center in the thickness direction, a negative electrode mixture layer (a) is one half on the negative electrode collector side of the negative electrode mixture layer and contains the first binding material, and a negative electrode mixture layer (b) is the other half on the surface side of the negative electrode mixture layer and contains the second binding material. A and B satisfy a relationship: 0.04≦B/(A+B)<0.5 where the A is a content of the first and second binding materials relative to the mass of the negative active material in the negative electrode mixture layer (a) and the B is a content of the first and second binding materials relative to the mass of the negative active material in the negative electrode mixture layer (b).

### BACKGROUND

1. Technical Field

The present disclosure relates to a negative electrode plate for nonaqueous electrolyte secondary battery and a method of producing the same.

2. Description of the Related Art

A nonaqueous electrolyte secondary battery includes a positive electrode plate, a negative electrode plate, and a separator lying between the positive electrode plate and the negative electrode plate. Nonaqueous electrolyte secondary batteries including various carbon materials such as graphite particles or silicon as the negative active materials in the negative electrode plates have been practically used. These negative active materials cannot be independently formed on a thin film, and, in general, a negative electrode mixture layer containing a negative active material and a binding material (binder) is used as the negative electrode plate. The negative electrode mixture layer is formed by applying, onto a negative electrode collector, a composition in a paste, slurry, or ink form prepared by dispersing the negative active material and the binding material in an appropriate solvent (e.g., water), and drying the composition.

The performance of a battery can be further improved by increasing the thickness of the negative electrode mixture layer containing a negative active material. An increase in the thickness of a negative electrode mixture layer, however, generally decreases the binding property between the negative electrode mixture layer and the negative electrode collector. The decrease in the binding property can be compensated by increasing the content of the binding material in the negative electrode mixture layer, but such an increase in the amount of the binding material may decrease the flexibility of the negative electrode mixture layer. If the negative electrode mixture layer has too low flexibility, when the negative electrode mixture layer formed on a negative electrode collector is compressed (rolled) in the production of a negative electrode plate for imparting a desired mixture density to the negative electrode mixture layer, the negative electrode mixture layer cannot follow the negative electrode collector and is peeled off at the interface with the negative electrode mixture layer. The negative electrode plate for nonaqueous electrolyte secondary battery is, therefore, required to have a negative electrode mixture layer having a high binding property to a negative electrode collector and having a certain degree of flexibility.

Japanese Unexamined Patent Application Publication No. 2010-182626 describes a negative electrode plate for nonaqueous secondary battery having improved adhesion, flexibility, and peeling characteristics during pressing of the negative electrode mixture layer by using a mixture of two binding materials having different glass transition temperatures (Tg) and different average particle diameters.

### SUMMARY

One non-limiting and exemplary embodiment provides a negative electrode plate for nonaqueous electrolyte secondary battery including a negative electrode mixture layer having a high binding property to a negative electrode collector and excellent flexibility, where a nonaqueous electrolyte secondary battery produced using the negative electrode plate shows excellent discharge output characteristics at room temperature and a low temperature environment and provides a method of producing the negative electrode plate.

In one general aspect, the techniques disclosed here feature a negative electrode plate for nonaqueous electrolyte secondary battery including a negative electrode collector and a negative electrode mixture layer disposed on the negative electrode collector, wherein the negative electrode mixture layer contains a negative active material, a first binding material having a glass transition temperature (Tg) of 10° C. to 60° C., and a second binding material having a glass transition temperature (Tg) of 0° C. or less; the negative electrode mixture layer (a) that is one half on the negative electrode collector side of the negative electrode mixture layer contains the first binding material; the negative electrode mixture layer (b) that is the other half on the surface side of the negative electrode mixture layer contains the second binding material when the negative electrode mixture layer is divided into two equal parts at the center in the thickness direction; and A and B satisfy a relationship: 0.04≦B/(A+B)<0.5 where the A is a content of the first and second binding materials relative to the mass of the negative active material in the negative electrode mixture layer (a) and the B is a content of the first and second binding materials relative to the mass of the negative active material in the negative electrode mixture layer (b).

The negative electrode plate for nonaqueous electrolyte secondary battery according to the present disclosure includes a negative electrode mixture layer having a high binding property to a negative electrode collector and excellent flexibility. The nonaqueous electrolyte secondary battery produced using the negative electrode plate for nonaqueous electrolyte secondary battery according to the present disclosure exhibits excellent discharge output characteristics at room temperature and also at a low temperature environment.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an electrode assembly of a nonaqueous electrolyte secondary battery according to an embodiment of the present disclosure;

FIG. 2 is a diagram illustrating a negative electrode plate according to an embodiment of the present disclosure;

FIGS. 3A and 3B are diagrams illustrating a method of producing a negative electrode plate according to an embodiment of the present disclosure; and

FIG. 4 is a diagram illustrating a tester used in flexibility evaluation and a method of the test.

### DETAILED DESCRIPTION

In an aspect of the present disclosure, a negative electrode plate for nonaqueous electrolyte secondary battery includes a negative electrode collector and a negative electrode mixture layer disposed on the negative electrode collector. The negative electrode mixture layer contains a negative active material, a first binding material having a Tg of 10° C. to 60° C., and a second binding material having a Tg of 0° C. or less. When the negative electrode mixture layer is divided into two equal parts at the center in the thickness direction, a negative electrode mixture layer (a) is one half on the negative electrode collector side of the negative electrode mixture layer and contains the first binding material, and a negative electrode mixture layer (b) is the other half on the surface side of the negative electrode mixture layer and contains the second binding material. A (% by mass) and B (% by mass) satisfy a relationship: 0.04≦B/(A+B)<0.5 where the A is a content of the first and second binding materials relative to the mass of the negative active material in the negative electrode mixture layer (a) and the B is a content of the first and second binding materials relative to the mass of the negative active material in the negative electrode mixture layer (b). For example, the negative electrode mixture layer (a) is divided into two equal parts at the center in the thickness direction, a negative electrode mixture layer (c) is one half on the negative electrode collector side of the negative electrode mixture layer (a), and a negative electrode mixture layer (d) is the other half of the negative electrode mixture layer (a) disposed between negative electrode mixture layer (c) and the negative electrode mixture layer (b); and B (% by mass), C (% by mass) and D (% by mass) satisfy a relationship: C>D>B where the C is content of the first and second binding materials relative to the mass of the negative active material in the negative electrode mixture layer (c) and the D is content of the first and second binding materials relative to the mass of the negative active material in the negative electrode mixture layer (d). For example, the first binding material and the second binding material are styrene butadiene rubbers having different glass transition temperatures (Tg). In an aspect of the present disclosure, a method of producing a negative electrode plate for nonaqueous electrolyte secondary battery includes forming a first application layer by applying an application composition containing a first binding material having a glass transition temperature (Tg) of 10° C. to 60° C. onto a surface of a negative electrode collector, forming a first negative electrode mixture layer by drying the first application layer formed on the negative electrode collector at a temperature not higher than the glass transition temperature (Tg) of the first binding material, forming a second application layer by applying a composition containing a negative active material and a second binding material having a glass transition temperature (Tg) of 0° C. or less onto the surface of the first negative electrode mixture layer, forming a negative electrode mixture layer by drying the second application layer. An embodiment of the present disclosure will now be described in detail with reference to the drawings. The drawings referred to in the embodiment are schematic, and the dimensional ratios of components and other factors shown in the drawings may be different from those of actual one. Specific dimensional ratios, shapes, and other factors can be judged from the following descriptions and can be appropriately modified according to the use, purpose, and mode of the nonaqueous electrolyte secondary battery.

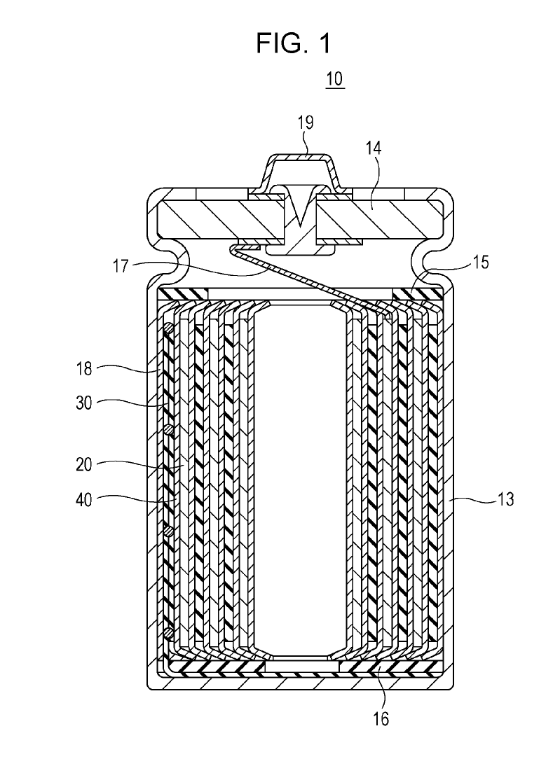

FIG. 1 is a cross-sectional view illustrating a nonaqueous electrolyte secondary battery 10, which is an example according to an embodiment of the present disclosure. The nonaqueous electrolyte secondary battery 10 includes a positive electrode plate 20, a negative electrode plate 30, a separator 40 lying between the positive electrode plate 20 and the negative electrode plate 30, and a nonaqueous electrolyte (not shown). The positive electrode plate 20 and the negative electrode plate 30 are wound with the separator 40 therebetween to construct a wound electrode group together with the separator 40. The nonaqueous electrolyte secondary battery 10 includes a cylindrical battery case 13 and a sealing plate 14. The battery case 13 accommodates the wound electrode group and the nonaqueous electrolyte. An upper insulating plate 15 and a lower insulating plate 16 are disposed on both ends of the wound electrode group in the longitudinal direction. The positive electrode plate 20 is connected to one end of a positive electrode lead 17. The other end of the positive electrode lead 17 is connected to a positive electrode terminal 19 disposed in the sealing plate 14. The negative electrode plate 30 is connected to one end of a negative electrode lead 18. The other end of the negative electrode lead 18 is connected to the bottom inside the battery case 13. The opening end of the battery case 13 is swaged to the sealing plate 14 to seal the battery case 13.

FIG. 1 shows an example of a cylindrical battery including a wound electrode group. The battery according to the present disclosure is not limited to this and may be, for example, a square battery, a flat battery, a coin battery, or a laminate film pack battery.

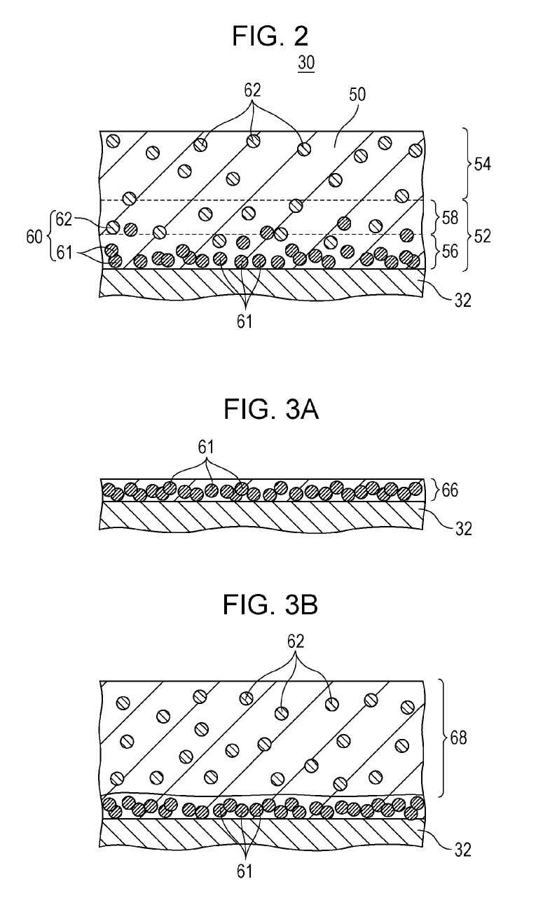

FIG. 2 is a diagram illustrating the structure of a negative electrode plate for nonaqueous electrolyte secondary battery 30 (hereinafter, also simply referred to as “negative electrode plate 30”) according to an embodiment of the present disclosure. The negative electrode plate 30 according to the embodiment of the present disclosure includes a negative electrode mixture layer (a) 52 that is one half on the negative electrode collector 32 side of the negative electrode mixture layer and a negative electrode mixture layer (b) 54 that is another half on the surface side of the negative electrode mixture layer, when the negative electrode mixture layer is divided into two equal parts at the center in the thickness direction. The negative electrode mixture layer (a) 52 contains the first binding material 61, and the negative electrode mixture layer (b) 54 contains the second binding material 62. Components of the negative electrode plate 30 according to the embodiment of the present disclosure will now be described in detail.

### Negative Electrode Plate

The negative electrode plate 30 includes a belt-shaped negative electrode collector 32 and a negative electrode mixture layer 50 disposed on the negative electrode collector 32.

The negative electrode mixture layer 50 is a layer formed by binding fine particles or particles of a negative active material with binding materials 60. The mixture used for the negative electrode mixture layer 50 contains the negative active material and the binding materials 60 and optionally contains a thickener. The binding materials 60 in the negative electrode mixture layer 50 are used for maintaining the good contact between fine particles or particles of the negative active material and enhancing the binding property of the negative active material and additional components to the surface of the negative electrode collector 32. The negative electrode mixture layer 50 has a thickness of, for example, 20 to 200 μm.

The negative electrode mixture layer 50 according to this embodiment contains a first binding material 61 having a glass transition temperature (Tg) of 10° C. to 60° C. and a second binding material 62 having a glass transition temperature (Tg) of 0° C. or less. When the negative electrode mixture layer 50 is divided into two equal parts at the center in the thickness direction, the negative electrode mixture layer (a) 52 that is one half of the negative electrode mixture layer 50 contains the first binding material 61, and the negative electrode mixture layer (b) 54 that the other half of the negative electrode mixture layer 50 contains the second binding material 62. In the negative electrode mixture layer 50, the first binding material 61 having a higher Tg exists near the interface with the negative electrode collector 32 and enhances the binding property of the negative electrode mixture layer 50 to the negative electrode collector 32, whereas the second binding material 62 having a lower Tg exists in the negative electrode mixture layer (b) 54 and imparts appropriate flexibility to the negative electrode mixture layer 50.

In the negative electrode mixture layer 50 according to this embodiment, the content A (% by mass) of the binding materials 60 relative to the mass of the negative active material in the negative electrode mixture layer (a) 52 and the content B (% by mass) of the binding materials 60 relative to the mass of the negative active material in the negative electrode mixture layer (b) 54 satisfy a relationship: 0.04≦B/(A+B)<0.5. The ratio B/(A+B) is preferably 0.06 or more and 0.3 or less. The content of the binding materials 60 in the negative electrode mixture layer (a) 52 on the negative electrode collector side is high, which enhances the binding property of the negative electrode mixture layer 50 to the negative electrode collector 32. In addition, the content of the binding materials 60 in the negative electrode mixture layer (b) 54 on the surface side is low, which enhances the flexibility of the negative electrode mixture layer 50. As a result, peeling during compression or press forming is inhibited. The enhancement in the binding property between the collector and the negative active material enhances the electrical characteristics, and the reduced content of the binding materials 60 in the negative electrode mixture layer 50 on the surface side smoothens the transfer of the electrolyte such as lithium ions. The nonaqueous electrolyte secondary battery produced using the negative electrode plate 30 according to this embodiment, therefore, has excellent discharge output characteristics.

The negative electrode mixture layer 50 according to this embodiment has the above-described structure and can thereby enhance the binding property between the negative electrode mixture layer 50 and the negative electrode collector 32 and simultaneously enhance the flexibility of the negative electrode mixture layer 50. Accordingly, the discharge output characteristics can be further improved by further reducing the total amount of the binding materials 60 in the negative electrode mixture layer 50. In addition, the excellent binding property and flexibility allow the negative electrode mixture layer 50 to have an increased thickness, which improves the battery characteristics.

In the negative electrode mixture layer 50 according to this embodiment, the content of the binding materials in the mixture is preferably the highest in the vicinity (for example, 30% or less of the thickness of the negative electrode mixture layer from the interface) of the interface with the negative electrode collector 32. In such a structure, the binding materials are concentrated near the interface between the negative electrode mixture layer 50 and the negative electrode collector 32 to enhance the binding property and inhibit peeling. More specifically, in the negative electrode mixture layer 50 according to this embodiment, when the negative electrode mixture layer (a) 52 is divided into two equal parts at the center in the thickness direction, the negative electrode mixture layer (c) 56 is one half on the negative electrode collector side of the negative electrode mixture layer (a) 52, and the negative electrode mixture layer (d) 58 is the other half on the negative electrode mixture layer (b) 54 side of the negative electrode mixture layer (a) 52, where the content C (% by mass) of the binding materials relative to the mass of the negative active material in the negative electrode mixture layer (c) 56 and the content D (% by mass) of the binding materials relative to the mass of the negative active material in the negative electrode mixture layer (d) 58 preferably satisfy a relationship: C>D>B. The ratio C/D is preferably higher than 1.0 and 50 or less and more preferably 2 or more and 20 or less.

The first binding material 61 has a Tg of 10° C. to 60° C. and preferably 15° C. to 55° C. The first binding material 61 having a Tg in this range can provide appropriate hardness and binding property to the negative electrode mixture layer 50, in particular, in the vicinity of the interface with the negative electrode collector 32.

The second binding material 62 has a Tg of 0° C. or less. If a binding material having a Tg of higher than 0° C. is used as the second binding material 62, the flexibility of the negative electrode mixture layer may decrease. The second binding material 62 does not specifically have a lower limit of the Tg, and the lower limit is, for example, −50° C. The second binding material 62 preferably has a Tg of −40° C. to 0° C.

The binding materials 60 can be made of polymers each can be dissolved or dispersed in an aqueous solvent, and examples thereof include rubber polymers, such as styrene-butadiene copolymers (SBRs), modified SBRs (SBRs modified with unsaturated carboxylic acid or a unsaturated nitrile compound), polyacrylates, and polyurethane; and fluorine polymers, such as polyvinylidene fluoride. The binding materials 60 contained in the negative electrode mixture layer 50 according to this embodiment are each preferably an SBR or modified SBR and more preferably an SBR. The use of an SBR can provide a negative electrode plate for nonaqueous secondary battery being chemically stable and having excellent binding property, flexibility, and peeling characteristics.

This embodiment uses two binding materials (first binding material 61 and second binding material 62) having different glass transition temperatures (Tg's). The use of SBRs as the first binding material 61 and the second binding material 62 can easily produce binding materials having different Tg's. The Tg of an SBR can be changed by, for example, varying the copolymerization ratio of styrene and butadiene or adding an additive or a crosslinking agent to the SBR. SBRs having various Tg values are commercially available.

The total amount of the first binding material 61 and the second binding material 62 in the negative electrode mixture layer 50 is preferably 0.45% by mass to 2.0% by mass based on the total amount of the mixture (solid content) of the negative electrode mixture layer 50. An amount of less than 0.45% by mass may deteriorate the current collecting properties due to insufficient binding strength. An amount of higher than 2.0% by mass may decrease the flexibility of the mixture layer and may inhibit the diffusion of lithium ions by the excess binding materials, which may cause deterioration of the characteristics.

The negative active material contained in the negative electrode mixture layer 50 may be any material that can occlude and release lithium ions, usually used in nonaqueous electrolyte secondary batteries. Examples of such a material include carbon materials, metals, alloys, metal oxides, metal nitrides, and lithium-occluded carbon or silicon compounds. Examples of the carbon materials include natural graphite, artificial graphite, and pitch-based carbon fibers. The carbon material can appropriately contain a material, such as silicon oxide, for enhancing battery characteristics. Examples of the metals and the alloys include lithium (Li), silicon (Si), tin (Sn), germanium (Ge), lead (Pb), indium (In), and gallium (Ga); and alloys of these metals. These materials as the negative active material may be used alone or in a mixture of two or more thereof.

The mixture for the negative electrode mixture layer 50 may contain a thickener, in addition to the negative active material and the binding materials 60. Examples of the thickener include polyethylene oxide and cellulose derivatives, more specifically, carboxymethyl cellulose (CMC), methyl cellulose (MC), and cellulose acetate phthalate (CAP).

The components, such as the negative active material and the binding materials 60, of the negative electrode mixture layer 50 preferably have a high volume density (mixture density), for example, preferably 1.4 g/cm³ or more, more preferably 1.5 g/cm³ or more, as the average from the viewpoint of increasing the capacity. The mixture density does not specifically have an upper limit, but a too high mixture density decreases the voids (hole volume) of the negative electrode mixture layer 50, which may cause insufficient infiltration of the nonaqueous electrolytic solution and a decrease in the output. The mixture density is preferably, for example, 1.75 g/cm³ or less as the average.

The glass transition temperature (Tg) of the binding materials 60 contained in the negative electrode mixture layer 50 can be readily measured by sampling the mixture at each region of the negative electrode mixture layer 50 and analyzing the Tg of each sample with a differential scanning calorimeter (DSC) in an inert gas.

The content of the binding materials 60 in the negative electrode mixture layer 50 can be measured as follows. The negative electrode plate 30 is cut in parallel to the thickness direction; the section is stained with bromine (Br) to add the bromine to the binding materials 60 in the negative electrode mixture layer 50. The sample stained with bromine is sufficiently washed with water and is then dried. The local distribution of the content of bromine in the section of the negative electrode mixture layer 50 is measured with an electron probe microanalyzer (EPMA). The results of the measurement are mapped, and the resulting map is subjected to image processing to digitize the local distribution of the content of the binding materials 60. Thus, the content of the binding materials 60 in each region relative to the total amount of the binding materials 60 in the negative electrode mixture layer can be measured. The content can be converted into the content of the binding materials 60 relative to the amount of the negative active material in each region of the negative electrode mixture layer using the contents of the negative active material and the binding materials 60 in the mixture. On this occasion, the contents of the components, such as the negative active material, the binding materials 60, and the thickener, in the negative electrode mixture layer 50 can be measured by gas chromatography. The distribution of the content of bromine can also be measured by Auger electron spectroscopy (AES) or scanning probe microscopy (SPM).

The negative electrode collector 32 used in the negative electrode plate 30 according to this embodiment is a conductive thin-film sheet, such as metal foil that hardly forms an alloy with lithium in the potential range of the negative electrode plate 30 or a film having a surface layer of a metal that hardly forms an alloy with lithium in the potential range of the negative electrode plate 30. The metal for the negative electrode plate 30 is preferably a metal mainly composed of copper, because of its low cost, easiness in processing, and high electron conductivity. Preferred examples of the negative electrode collector 32 include electrolytic copper foil, rolled copper foil, and copper foil containing a foreign element, such as Zr, Ag, or Cr. The negative electrode collector 32 has a thickness, for example, about 5 to 20 μm.

FIGS. 3A and 3B are diagrams illustrating a method of producing a negative electrode plate according to an embodiment of the present disclosure. The negative electrode plate 30 according to this embodiment is produced by a method including (1) a first application step (see FIG. 3A) of forming a first application layer 66 by application of a first composition containing the first binding material 61 onto the surface of the negative electrode collector; (2) a first drying step of forming a first negative electrode mixture layer by drying the first application layer 66 formed on the negative electrode collector in an atmosphere of a temperature of not higher than the glass transition temperature (Tg) of the first binding material 61; (3) a second application step (see FIG. 3B) of forming a second application layer 68 by application of a second composition containing the negative active material and the second binding material 62 onto the surface of the first negative electrode mixture layer; and (4) a second drying step of forming a second negative electrode mixture layer by drying the second application layer 68.

The first composition in the first application step is a composition in a paste, slurry, or ink form prepared by dissolving or dispersing the first binding material 61 in a solvent, such as water or an aqueous solvent. The first composition may contain a negative active material, but preferably does not contain any negative active material, because a layer densely containing a first binding material 61 having a high binding property can be formed in the negative electrode mixture layer 50 in the vicinity of the interface with the negative electrode collector 32. The first composition may contain the above-mentioned thickener. The first application step preferably control the content of the first binding material 61 in the first composition and the application amount of the first composition such that the content of the first binding material 61 is 0.4% to 1.9% by mass based on the total amount of the negative active material in the resulting negative electrode mixture layer 50. If the content of the first binding material 61 is less than 0.4% by mass based on the total amount of the negative active material in the negative electrode mixture layer 50, the current collecting properties may be deteriorated due to insufficient binding strength, whereas an amount of higher than 1.9% by mass may decrease the flexibility of the mixture layer and may increase the electronic resistance between the active material and the collector due to the excess binding material. The first composition may be applied to the surface of the negative electrode collector by any method and may be applied with a known application device, such as a gravure coater, slit coater, or die coater.

The first negative electrode mixture layer formed in the first drying step preferably has a dried thickness of 0.5 to 5 μm. A too small thickness of the first negative electrode mixture layer may reduce the binding property to the collector layer, whereas a too large thickness of the first negative electrode mixture layer may reduce the flexibility of the negative electrode mixture layer 50 due to the increased content of the first binding material 61 having a high Tg in the negative electrode mixture layer 50 and may inhibit the movement of electrons between the negative active material and the negative electrode collector 32 due to a layer of the first binding material in application of the first composition not containing any negative active material.

The second composition in the second application step is a composition in a paste, slurry, or ink form prepared by dissolving or dispersing the second binding material 62, the negative active material, and the optional thickener in a solvent, such as water or an aqueous solvent. In the second application step, the content of the second binding material 62 in the second composition and the application amount of the second composition are preferably controlled such that the content of the second binding material 62 is 0.02% to 1.5% by mass based on the total amount of the negative active material in the resulting negative electrode mixture layer 50. If the content of the second binding material 62 is less than 0.02% by mass based on the total amount of the negative active material in the negative electrode mixture layer 50, the negative electrode mixture layer 50 may be detached due to an insufficient binding strength. An amount of higher than 1.5% by mass may decrease the flexibility of the negative electrode mixture layer 50 and may inhibit the diffusion of lithium ions due to the excess binding material, which may cause deterioration of the characteristics. The second composition may be applied to the surface of the first negative electrode mixture layer formed in the first drying step by any method and may be applied with a known application device, such as a gravure coater, slit coater, or die coater.

The second application layer 68 is dried in the second drying step to form a second negative electrode mixture layer. The second drying step may be performed at any atmospheric temperature and is preferably performed at 50° C. to 105° C.

In the method of producing a negative electrode plate according to this embodiment, the solvent in the second application layer on the first negative electrode mixture layer formed in the first drying step infiltrates into the first negative electrode mixture layer. A part of the first binding material in the first negative electrode mixture layer is dispersed or dissolved in this solvent and is separated from the first negative electrode mixture layer. The first negative electrode mixture layer containing the first binding material is, however, in binding to the negative electrode collector layer by the first drying step, and the amount of the first binding material separated from the first negative electrode mixture layer in the second application step is small compared to the amount of the first binding material remaining in the first negative electrode mixture layer. The content of the first binding material is, therefore, still high in the vicinity of the interface with the negative electrode collector layer.

Although it depends on the amount of the second binding material in the second application layer, the second binding material moves toward the surface side in association with the movement of the solvent during from the start to the completion of the second drying step, i.e., during the drying of the second application layer on the surface of the first negative electrode mixture layer formed in the first drying step to be formed into the second negative electrode mixture layer. As a result, the second binding material may be unevenly distributed in the second negative electrode mixture layer by migration causing localization of the second binding material on the surface side. In this embodiment, however, as described above, the second negative electrode mixture layer receives a part of the first binding material from the first negative electrode mixture layer, and the total amount of the binding material is high in the vicinity of the interface with the negative electrode collector layer. Accordingly, even if the migration is caused, a good negative electrode mixture layer that is hardly affected by the migration is obtained.

The negative electrode mixture layer of the negative electrode plate according to this embodiment includes the first negative electrode mixture layer and the second negative electrode mixture layer formed through the above-described steps. The negative electrode mixture layer of the negative electrode plate according to this embodiment may further includes other negative electrode mixture layers containing a binding material and a negative active material, in addition to the first negative electrode mixture layer and the second negative electrode mixture layer, by further performing a step of applying a composition containing the binding material and the negative active material after the second application step and before the second drying step or a step of applying a composition containing the binding material and the negative active material after the second drying step and drying the resulting application layer.

The laminate having the negative electrode collector, the first negative electrode mixture layer, and the second negative electrode mixture layer, produced through the first application step, the first drying step, the second application step, and the second drying step, is compressed (rolled) for obtaining a desired mixture density. The compression may be performed by a known method, for example, using a pressure roll. For example, in a square nonaqueous electrolyte secondary battery, compression can be performed by winding a negative electrode plate and a positive electrode plate in belt-like shapes into a cylindrical form with a separator between the electrode plates to form an insulated state and then flattening the wound electrode plates.

Each component of the nonaqueous electrolyte secondary battery will now be described in detail.

### Positive Electrode Plate

The positive electrode plate 20 includes a belt-shaped positive electrode collector and a positive electrode mixture layer disposed on the positive electrode collector. The positive electrode collector is, for example, metal or alloy foil that is stable in the potential range of the positive electrode or a film having a surface layer of a metal that is stable in the potential range of the positive electrode. The metal for the positive electrode collector is preferably a metal mainly composed of aluminum, such as aluminum or an aluminum alloy, because of its stability in the potential range of the positive electrode.

The mixture for the positive electrode mixture layer contains a positive active material and preferably further contains a conducting agent and a binding material. The positive electrode mixture layer is formed by, for example, applying a positive mixture slurry composed of the above-mentioned components and an appropriate solvent onto the positive electrode collector and the drying and rolling (compressing) the resulting coating film.

Examples of the positive active material include transition metal oxides containing alkali metal elements and transition metal oxides in which a part of the transition metal elements contained therein are substituted with different elements. The positive active material is usually in a particle form. Examples of the alkali metal element include lithium (Li) and sodium (Na), and Li is preferable. The transition metal element can be at least one selected from the group consisting of scandium (Sc), manganese (Mn), iron (Fe), cobalt (Co), nickel (Ni), copper (Cu), and yttrium (Y). In particular, Mn, Co, and Ni are preferable. The different element can be at least one selected from the group consisting of magnesium (Mg), aluminum (Al), lead (Pb), antimony (Sb), and boron (B). In particular, Mg and Al are preferable.

More specifically, examples of the positive active material include lithium-containing transition metal oxides containing lithium as the alkali metal element, such as LiCoO₂, LiNiO₂, LiMn₂O₄, LiMnO₂, LiNi_{1-y}Co_{y}O₂ (0<y<1), LiNi_{1-y-z}Co_{y}Mn_{z}O₂ (0<y+z<1), and LiFePO₄. In this embodiment, the positive active materials may be used alone or in a combination of two or more thereof.

The conducting agent is conductive fine particles or particles and is used for enhancing the electron conductivity of the positive electrode mixture layer. The conducting agent is, for example, a carbon material, metal powder, or organic material having conductivity. Specifically, examples of the carbon material include acetylene black, Ketjen black, and graphite; examples of the metal powder include aluminum; examples of the metal oxide include potassium titanate and titanium oxide; and examples of the organic material include phenylene derivatives. These conducting agents may be used alone or in a combination of two or more thereof.

The binding material in the positive electrode mixture layer is a polymer having a particulate shape or a network structure and is used for maintaining the good contact between the particulate positive active material and the conducting agent in a fine particle or particle form and enhancing the binding property of, for example, the positive active material to the surface of the positive electrode collector. The binding material in the positive electrode mixture layer can be a fluorine polymer or a rubber polymer. Specifically, examples of the fluorine polymer include polytetrafluoroethylene (PTFE), polyvinylidene fluoride (PVDF), and modified products thereof; examples of the rubber polymer include ethylene-propylene-isoprene copolymers and ethylene-propylene-butadiene copolymers. The positive electrode mixture layer may contain a thickener, such as carboxymethyl cellulose (CMC) or polyethylene oxide (PEO), in addition to the binding material.

### Nonaqueous Electrolyte

The nonaqueous electrolyte includes a nonaqueous solvent and a solute (electrolyte salt) dissolved in the nonaqueous solvent. The nonaqueous electrolyte is not limited to a liquid electrolyte, which is a nonaqueous electrolytic solution, and may be a solid electrolyte, such as a gelatinous polymer.

The nonaqueous solvent is not particularly limited and may be a known solvent, such as a cyclic carbonate, chain carbonate, nitrile, or amide. Specifically, examples of the solvent include cyclic carbonates, such as ethylene carbonate, propylene carbonate, butylene carbonate, and vinylene carbonate; chain carbonates, such as dimethyl carbonate, methyl ethyl carbonate, and diethyl carbonate; ester-based solvents, such as methyl acetate, ethyl acetate, propyl acetate, methyl propionate, ethyl propionate, and γ-butyrolactone; ether-based solvents, such as 1,2-dimethoxyethane, 1,2-diethoxyethane, tetrahydrofuran, 1,2-dioxane, 1,4-dioxane, and 2-methyltetrahydrofuran; nitrile solvents, such as butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile; and amide solvents, such as dimethylformamide. Halogen-substituted derivatives of these solvents, having hydrogen atoms partially substituted with halogen atoms, such as fluorine atoms, can also be used. These nonaqueous solvents may be used alone or in a combination of two or more thereof.

The electrolyte salt can be a lithium salt, which is usually used as a supporting electrolyte in nonaqueous electrolyte secondary batteries. The lithium salt that can be used includes at least one element selected from the group consisting of P, B, F, O, S, N, and CI, and examples of the lithium salt include LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, LiAsF₆, LiCIO₄, and LiPF₂O₂. These lithium salts may be used alone or in a combination of two or more thereof.

The nonaqueous electrolyte can contain an additive for the purpose of, for example, forming a coating film having excellent ion permeability on the positive electrode plate 20 or the negative electrode plate 30. Examples of the additive include vinylene carbonate (VC), ethylene sulfite (ES), cyclohexylbenzene (CHB), and modified products thereof. These additives may be used alone or in a combination of two or more thereof. The additive may be contained in the nonaqueous electrolyte in any amount. The amount is preferably about 0.05 to 10% by mass based on the total amount of the nonaqueous electrolyte.

### Separator

The separator 40 is a porous film having ion permeability and insulation properties and is disposed between the positive electrode plate 20 and the negative electrode plate 30. Examples of the porous film include microporous thin films, woven cloth, and non-woven cloth. The material used in the separator is preferably polyolefin, more specifically, polyethylene or polypropylene.

### EXAMPLES

The present disclosure will now be more specifically described with reference to examples and comparative examples, but is not limited to the following examples. Examples 1 to 7 and Comparative Examples 1 to 3 produced negative electrode plates for nonaqueous electrolyte secondary battery and nonaqueous electrolyte secondary batteries including the negative electrode plates. The specific methods of producing the negative electrode plates and the nonaqueous electrolyte secondary batteries are as follows.

### Example 1

### Production of Negative Electrode Plate

A negative electrode plate was produced as follows. A dispersion (solid content: 10% by mass) of a styrene-butadiene copolymer (SBR) (first binding material) having a Tg of 35° C. was die-coated on one surface of electrolytic copper foil having a thickness of 10 μm serving as a negative electrode collector to form a first application layer (first application step). The laminate composed of the negative electrode collector and the first application layer formed on one surface of the negative electrode was dried with wind in an atmosphere of a temperature of 25° C. to form a first negative electrode mixture layer (first drying step). The dried first negative electrode mixture layer had a thickness of 3 μm. A mixture of 0.6 parts by mass of an SBR (second binding material) having a Tg of −20° C., 100 parts by mass of artificial graphite (negative active material), and 1 part by mass of CMC was added to water to prepare a slurry. This slurry was die-coated on the negative electrode collector of the first negative electrode mixture layer to form a second application layer (second application step). The laminate having the second application layer was dried in an atmosphere of a temperature of 80° C. to form a second negative electrode mixture layer (second drying step). The amount of the first binding material used in the first application step was 0.6% by mass based on the total amount of the negative active material contained in the negative electrode mixture layer. The amount of the second binding material used in the second application step was 0.6% by mass based on the total amount of the negative active material. Similarly, on the other surface of the negative electrode collector, first and second negative electrode mixture layers were formed. On one end of the negative electrode collector in the long-side direction, a negative electrode collector-exposed portion was formed by not applying the slurry to both surfaces of the negative electrode collector in the end portion (the both surfaces are at the same end) to expose the negative electrode collector. Subsequently, compression with a compressing roller was performed until the negative electrode mixture layer had a mixture density of 1.5 g/cm³ to produce a negative electrode plate. The negative electrode mixture layer of this negative electrode plate had a thickness of 140 μm.

### Production of Positive Electrode Plate

A positive electrode plate was produced as follows. A positive electrode mixture paste was prepared by kneading 100 parts by mass of LiNiCoMnO₂ (positive active material), 4 parts by mass of acetylene black (conducting agent), 50 parts by mass of a solution (solid content: 12% by mass) of polyvinylidene fluoride (PVdF, binding material) in N-methyl-2-pyrrolidone (NMP), and an appropriate amount of NMP with a double-arm type kneader at 30° C. for 30 min. This positive electrode mixture paste was applied to both surfaces of a positive electrode collector of aluminum foil having a thickness of 20 μm by a doctor-blade method. On one end of the positive electrode collector in the long-side direction, a positive electrode collector-exposed portion was formed on this occasion by not applying the slurry to both surfaces of the positive electrode collector in the end portion (the both surfaces are at the same end) to expose the positive electrode collector. Subsequently, the positive electrode collector applied with the slurry was dried at 120° C. for 15 minutes and was then pressed with a roll press such that the total thickness of the positive electrode, i.e., the total thickness of the collector and the layer of the positive electrode mixture paste was 130 μm to form a positive electrode plate. The roll press was performed with a pair of rollers having a diameter of 40 cm at a linear pressure, which indicates the pressure during pressing, of 10000 N/cm. The preparation of the positive electrode mixture paste, application to the collector, and molding into a positive electrode were all performed in an environment that can maintain the dew point to be −30° C. or less.

### Preparation of Nonaqueous Electrolyte

A nonaqueous electrolytic solution was prepared by dissolving LiPF₆ (electrolyte salt) and vinylene carbonate (VC) at concentrations of 1.2 mol/L and 4% (mass ratio), respectively, in a nonaqueous solvent mixture of ethylene carbonate (EC), ethyl methyl carbonate (EMC), and dimethyl carbonate (DMC) (volume ratio of 2:3:5).

### Production of Nonaqueous Electrolyte Secondary Battery

A cylindrical nonaqueous electrolyte secondary battery (hereinafter, referred to as cylindrical battery) was produced from the resulting negative electrode plate, positive electrode plate, and nonaqueous electrolytic solution and a composite film (separator) of polyethylene and polypropylene having a thickness of 20 μm by the following procedure. The negative electrode plate produced above was cut into a strip form having a predetermined size. A negative electrode lead was attached to a part of the negative electrode plate. Similarly, the positive electrode plate was cut into a strip form having a predetermined size, and a positive electrode lead was attached to a part of the positive electrode plate. These positive electrode plate and negative electrode plate were wound with the separator therebetween to produce a wound electrode assembly. Subsequently, insulating plates were disposed on the top and the bottom of the wound electrode assembly. The wound electrode assembly was placed in a cylindrical battery outer can of steel having a diameter of 18 mm and a height of 65 mm such that the wound electrode assembly functions as a negative electrode terminal. The current collection tab of the negative electrode was welded to the bottom inside the battery outer can, and the current collection tab of the positive electrode was welded to the bottom plate part of a u including a safety device. The electrolytic solution was put in the battery outer can through the opening of the can. The battery outer can was sealed with the current interruption sealing body including a safety valve and a current interrupting device to give a cylindrical battery with a design capacity of 2500 mAh.

### Example 2

A negative electrode plate and a cylindrical battery of Example 2 were produced as in Example 1 except that the slurry used in the second application step was prepared by adding water to a mixture of 0.2 parts by mass of an SBR (second binding material) having a Tg of −20° C., 100 parts by mass of artificial graphite (negative active material), and 1 part by mass of carboxymethyl cellulose (CMC) and that the amount of the second binding material was 0.2% by mass based on the total amount of the negative active material. The negative electrode mixture layer of the negative electrode plate in Example 2 had a thickness of 150 μm.

### Example 3

A negative electrode plate and a cylindrical battery of Example 3 were produced as in Example 1 except that the slurry used in the second application step was prepared by adding water to a mixture of 0.05 parts by mass of an SBR (second binding material) having a Tg of −20° C., 100 parts by mass of artificial graphite (negative active material), and 1 part by mass of carboxymethyl cellulose (CMC) and that the amount of the second binding material was 0.05% by mass based on the total amount of the negative active material. The negative electrode mixture layer of the negative electrode plate in Example 3 had a thickness of 150 μm.

### Example 4

A negative electrode plate and a cylindrical battery of Example 4 were produced as in Example 1 except that the slurry used in the second application step was prepared by adding water to a mixture of 1.1 parts by mass of an SBR (second binding material) having a Tg of −20° C., 100 parts by mass of artificial graphite (negative active material), and 1 part by mass of carboxymethyl cellulose (CMC) and that the amount of the second binding material was 1.1% by mass based on the total amount of the negative active material. The negative electrode mixture layer of the negative electrode plate in Example 4 had a thickness of 150 μm.

### Example 5

A negative electrode plate and a cylindrical battery of Example 5 were produced as in Example 1 except that a dispersion (solid content: 10% by mass) of an SBR (first binding material) having a Tg of 10° C. was used as the binding material in the first application step instead of the dispersion (solid content: 10% by mass) of an SBR having a Tg of 35° C. The negative electrode mixture layer of the negative electrode plate in Example 5 had a thickness of 150 μm.

### Example 6

A negative electrode plate and a cylindrical battery of Example 6 were produced as in Example 1 except that a dispersion (solid content: 10% by mass) of an SBR (first binding material) having a Tg of 60° C. was used as the binding material in the first application step instead of the dispersion (solid content: 10% by mass) of an SBR having a Tg of 35° C. The negative electrode mixture layer of the negative electrode plate in Example 6 had a thickness of 150 μm.

### Example 7

A negative electrode plate and a cylindrical battery of Example 7 were produced as in Example 1 except that an SBR (second binding material) having a Tg of 0° C. was used as the binding material in the second application step instead of the SBR having a Tg of −20° C. The negative electrode mixture layer of the negative electrode plate in Example 7 had a thickness of 150 μm.

### Comparative Example 1

A negative electrode plate of Comparative Example 1 was produced as follows. A slurry was prepared by adding water to a mixture of 0.6 parts by mass of a binding material composed of an SBR having a Tg of 35° C. and an SBR having a Tg of −20° C. at a ratio of 9:1, 100 parts by mass of artificial graphite (negative active material), and 1 part by mass of CMC (thickener). This slurry was die-coated on both surfaces of a negative electrode collector of electrolytic copper foil having a thickness of 10 μm to form application layers. The laminate composed of the negative electrode collector and the application layers on both surfaces of the negative electrode collector was dried in an atmosphere of a temperature of 80° C. to form a negative electrode mixture layer. On one end of the negative electrode collector in the long-side direction, a negative electrode collector-exposed portion was formed by not applying the slurry to both surfaces of the negative electrode collector in the end portion (the both surfaces are at the same end) to expose the negative electrode collector. Subsequently, compression with a compressing roller was performed until the negative electrode mixture layer had a mixture density of 1.5 g/cm³ to produce a negative electrode plate of Comparative Example 1. A cylindrical battery of Comparative Example 1 was produced as in Example 1 except that the negative electrode plate of Comparative Example 1 was used. The negative electrode mixture layer of the negative electrode plate of Comparative Example 1 had a thickness of 150 μm.

### Comparative Example 2

A negative electrode plate and a cylindrical battery of Comparative Example 2 were produced as in Comparative Example 1 except that a slurry was prepared by adding water to a mixture of 1.2 parts by mass of a binding material composed of an SBR having a Tg of 35° C. and an SBR having a Tg of −20° C. at a ratio of 9:1, 90 parts by mass of artificial graphite (negative active material), and 1 part by mass of CMC (thickener). The negative electrode mixture layer of the negative electrode plate of Comparative Example 2 had a thickness of 150 μm.

### Comparative Example 3

A negative electrode plate of Comparative Example 3 was produced as in Example 1 except that a dispersion (solid content: 10% by mass) of a styrene-butadiene copolymer (SBR) having a Tg of −20° C. was used as the dispersion for forming the first application layer and that an SBR having a Tg of 35° C. was used instead of the SBR having a Tg of −20° C. in the slurry used for forming the second application layer. The negative electrode mixture layer of the negative electrode plate of Comparative Example 3 had a thickness of 150 μm. In the negative electrode plate of Comparative Example 3, exfoliation occurred at the interface between the first negative electrode mixture layer and the second negative electrode mixture layer of the negative electrode mixture layer. No cylindrical battery, therefore, could be produced using the negative electrode plate of Comparative Example 3.

### Measurement of Content of Binding Material

The negative electrode plates of Examples 1 to 7 and Comparative Examples 1 to 3 were subjected to measurement of content distribution of the binding material in the negative electrode mixture layer with an electron probe microanalyzer (EPMA) by the following method. Since copper foil reacts to bromine, the copper foil was peeled off from the negative electrode plate in advance by immersing each negative electrode plate in an aqueous solution of HNO₃ (1 N). The negative electrode mixture layer, the copper foil of which has been peeled off, was immersed in pure water and was cleaned until the water became neutral. The cleaned negative electrode plate was immersed in an aqueous solution of bromine (2%) for 30 sec for staining. The negative electrode plate after the staining was immersed in pure water for 1 hr to remove the unreacted bromine. During the washing with water, the pure water was replaced with fresh one three to five times. After drying, the negative electrode plate was embedded in an epoxy resin. A polished section was prepared and was subjected to area analysis of bromine with an EPMA. The results of the analysis with the EPMA were mapped, and the resulting map was subjected to image processing to digitize the local content of the binding material relative to the total amount of the binding material contained in the negative electrode mixture layer.

Based on the analytical results in the negative electrode plates of Examples 1 to 7 and Comparative Examples 1 to 3, the amounts of the binding material contained in the negative electrode mixture layers (a) to (d) of each negative electrode plate were determined. Based on the results of the determination, contents A (% by mass), B (% by mass), C (% by mass), and D (% by mass) of the binding material relative to the mass of the negative active material in the respective regions were calculated. Table shows the values of B/(A+B), A/(A+B), B, C, and D in the negative electrode plates of Examples 1 to 7 and Comparative Examples 1 to 3.

The mixtures in the negative electrode mixture layer (a) and the negative electrode mixture layer (b) of each of the negative electrode plates of Examples 1 to 7 were sampled. The results of measurement of the samples with a differential scanning calorimeter (DSC) demonstrated that the first binding material having a Tg in a range of 10° C. to 60° C. was contained in the negative electrode mixture layer (a) and that the second binding material having a Tg of 0° C. or less was contained in the negative electrode mixture layer (b).

### Evaluation of Peeling Resistance Strength

The negative electrode plates of Examples 1 to 7 and Comparative Examples 1 to 3 were each evaluated for peeling resistance strength. A test piece of 120 mm×15 mm was cut out from each of the negative electrode plates of Examples and Comparative Examples. The cut-out belt-shaped test piece was glued to a horizontally fixed test table with double-sided adhesive tape applied to the one end side region of 80 mm×15 mm from the one end of the test piece. The other side region of 40 mm×15 mm was pulled in the direction orthogonal to the test table, and the power F (N) necessary for peeling the test piece from the double-sided adhesive tape was measured. On this occasion, the power F is the mean value from the time at which the test piece was peeled by 20 mm from the boundary between the one end side region of 80 mm×15 mm and the other side region of 40 mm×15 mm, i.e., the position from which the peeling started, to the time at which the test piece was peeled by 40 mm from the boundary. The peeling resistance strength (N/m) per unit length was determined from the mean value and the width (15 mm) of the test piece. The results are shown in Table. The peeling resistance strength of each negative electrode plate was evaluated by the following criteria:

◯: a peeling resistance strength of 2.0 N/m or more, and

x: a peeling resistance strength of less than 2.0 N/m.

### Evaluation of Flexibility

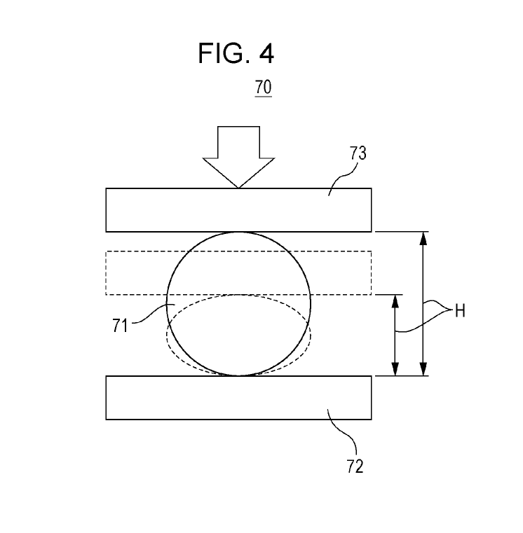

The negative electrode plates of Examples 1 to 7 and Comparative Examples 1 to 3 were evaluated for flexibility with the flexibility testing device 70 shown in FIG. 4. A cylindrical measurement sample 71 having a width of 10 mm and a circumference of 80 mm was produced from each electrode plate and was fixed to the lower flat plate 72 with a fixing tool (not shown). The upper flat plate 73 was brought into contact with the measurement sample 71 and was moved downward at a displacement velocity of 100 mm/min to press the measurement sample 71 downward. The force (electrode plate repulsion) (N) necessary for changing the distance H between the lower flat plate 72 and the upper flat plate 73 to 15 mm was measured. The results are shown in Table. The electrode plate repulsion of each negative electrode plate was evaluated by the following criteria:

◯: an electrode plate repulsion of less than 0.8 N, and

x: an electrode plate repulsion of 0.8 N or more.

### Evaluation of Discharge Characteristics

The batteries of Examples 1 to 7 and Comparative Examples 1 to 3 were charged at a constant current at room temperature (25° C.), and the state of charge of each battery was adjusted to 50%. The operating voltage range of the battery was set to 4.3 to 3.0 V. The discharge current of the battery was varied, and discharge was performed for 10 sec at each discharge current. The current-voltage value at each discharge current was measured. The output value (W) when the voltage after the discharge for 10 sec was not lower than 3 V and when the current value was the maximum was calculated from the current-voltage values.

The batteries of Examples 1 to 7 and Comparative Examples 1 to 3 were subjected to a charge and discharge test in an atmosphere of −30° C. as in above, and the output value (W) of each battery was calculated.

TABLE

| | | Example | Example | Example | Example | Example | Example |
|---|---|---|---|---|---|---|---|
| | | 1 | 2 | 3 | 4 | 5 | 6 |
| Binding | Tg (° C.) | −20 | −20 | −20 | −20 | −20 | −20 |
| material | Content (% by | 0.6 | 0.2 | 0.05 | 1.1 | 0.6 | 0.6 |
| contained in | mass) | | | | | | |
| second | (*1) | | | | | | |
| application | | | | | | | |
| layer | | | | | | | |
| Binding | Tg (° C.) | 35 | 35 | 35 | 35 | 10 | 60 |
| material | Content (% by | 0.6 | 0.6 | 0.6 | 0.6 | 0.6 | 0.6 |
| contained in | mass) | | | | | | |
| first | (*1) | | | | | | |
| application | | | | | | | |
| layer | | | | | | | |
| Content of | Negative | 0.32 | 0.17 | 0.05 | 0.48 | 0.29 | 0.32 |
| binding | electrode | | | | | | |
| material in | mixture layer | | | | | | |
| each negative | b: B/(A + B) | | | | | | |
| electrode | Negative | 0.68 | 0.83 | 0.95 | 0.52 | 0.71 | 0.68 |
| mixture layer | electrode | | | | | | |
| | mixture layer | | | | | | |
| | a: A/(A + B) | | | | | | |
| | Negative | 0.63% | 0.21% | 0.05% | 1.16% | 0.63% | 0.63% |
| | electrode | | | | | | |
| | mixture layer | | | | | | |
| | b: B (% by | | | | | | |
| | mass) | | | | | | |
| | Negative | 0.68% | 0.23% | 0.06% | 1.25% | 0.68% | 0.68% |
| | electrode | | | | | | |
| | mixture layer | | | | | | |
| | d: D (% by | | | | | | |
| | mass) | | | | | | |
| | Negative | 1.88% | 1.76% | 1.82% | 1.02% | 2.23% | 1.88% |
| | electrode | | | | | | |
| | mixture layer | | | | | | |
| | c: C (% by | | | | | | |
| | mass) | | | | | | |

| | | | | | | |
|---|---|---|---|---|---|---|
| Peeling resistance strength | ∘ 2.7 | ∘ 2.6 | ∘ 2.2 | ∘ 3.5 | ∘ 2.0 | ∘ 2.6 |
| (N/m) | | | | | | |
| Flexibility (electrode plate | ∘ 0.5 | ∘ 0.4 | ∘ 0.3 | ∘ 0.7 | ∘ 0.4 | ∘ 0.4 |
| repulsion) (N) | | | | | | |
| Discharge characteristics | 78 | 82 | 85 | 75 | 77 | 79 |
| (room temperature) (W) | | | | | | |
| Discharge characteristics | 9.8 | 10.3 | 10.7 | 9.4 | 9.7 | 9.9 |
| (−30° C.) (W) | | | | | | |

| | | | Comparative | Comparative | |
|---|---|---|---|---|---|
| | | Example | Example 1 | Example 2 | Comparative |
| | | 7 | (*2) | (*2) | Example 3 |
| Binding | Tg (° C.) | 0 | Addition of | Addition of | 35 |
| material | Content (% by | 0.6 | 0.6% by mass | 1.2% by mass | 0.6 |
| contained in | mass) | | of binding | of binding | |
| second | (*1) | | materials | materials | |
| application | | | having Tg of | having Tg of | |
| layer | | | 35° C. | 35° C. | |
| Binding | Tg (° C.) | 35 | and −20° C. at | and −20° C. at | −20 |
| material | Content (% by | 0.6 | a ratio of 9:1 | a ratio of 9:1 | 0.6 |
| contained in | mass) | | | | |
| first | (*1) | | | | |
| application | | | | | |
| layer | | | | | |
| Content of | Negative | 0.29 | 0.56 | 0.56 | 0.32 |
| binding | electrode | | | | |
| material in | mixture layer | | | | |
| each negative | b: B/(A + B) | | | | |
| electrode | Negative | 0.71 | 0.44 | 0.44 | 0.68 |
| mixture layer | electrode | | | | |
| | mixture layer | | | | |
| | a: A/(A + B) | | | | |
| | Negative | 0.63% | 0.63% | 1.26% | 0.63% |
| | electrode | | | | |
| | mixture layer | | | | |
| | b: B (% by | | | | |
| | mass) | | | | |
| | Negative | 0.68% | 0.53% | 0.98% | 0.36% |
| | electrode | | | | |
| | mixture layer | | | | |
| | d: D (% by | | | | |
| | mass) | | | | |
| | Negative | 2.15% | 0.39% | 0.86% | 2.22% |
| | electrode | | | | |
| | mixture layer | | | | |
| | c: C (% by | | | | |
| | mass) | | | | |

| | | | | |
|---|---|---|---|---|
| Peeling resistance strength | ∘ 2.1 | x 1.3 | ∘ 2.5 | x 0.2 |
| (N/m) | | | | |
| Flexibility (electrode plate | ∘ 0.3 | ∘ 0.7 | x 2.0 | x 1.6 |
| repulsion) (N) | | | | |
| Discharge characteristics | 82 | 72 | 60 | Not available |
| (room temperature) (W) | | | | to produce |
| | | | | battery |
| Discharge characteristics | 10.3 | 9.0 | 8.5 | Not available |
| (−30° C.) (W) | | | | to produce |
| | | | | battery |

(*1) Amount (% by mass) of each binding material relative to the total amount of the negative active material in the negative electrode mixture layer
(*2) Formation of negative electrode mixture layer having a single structure composed of two binding materials, a negative active material, and a thickener

Table summarizes the results of the tests of peeling resistance strength, evaluation of flexibility, and evaluation of discharge characteristics. Table demonstrates that the batteries of Examples 1 to 7 exhibited excellent characteristics in peeling resistance strength and flexibility, in particular, the batteries of Examples 2 and 3 maintained the excellent peeling resistance strength and exhibited higher values of discharge characteristics, in spite of the reduction in the amount of the second binding material. In contrast, in the batteries of Comparative Examples 1 and 2 each having a single negative electrode mixture layer formed from a mixture of a first binding material and a second binding material, the battery of Comparative Example 1 in which the amount of the binding materials was small did not satisfy the criteria for the peeling resistance strength, and the battery of Comparative Example 2 in which the amount of the binding materials was large had low flexibility. In the battery of Comparative Example 3 produced as in Example 1 except that the binding material in the negative electrode mixture layer disposed on the negative electrode collector side had a low Tg and that the binding material in the negative electrode mixture layer disposed on the surface side had a high Tg, both peeling resistance strength and flexibility were low. The nonaqueous electrolyte secondary batteries produced using the negative electrode plates of Examples 1 to 7 exhibited significantly excellent discharge output characteristics in both environments of room temperature and a low temperature of −30° C., compared to those of the nonaqueous electrolyte secondary batteries produced using the negative electrode plates of Comparative Examples 1 and 2.

This is probably caused by the improved binding property between the negative electrode mixture layer and the negative electrode collector and the improved flexibility as the whole negative electrode mixture layer obtained through the use of the negative electrode mixture layer in the negative electrode plate of the present disclosure containing a binding material having a Tg of 10° C. to 60° C. and a high binding property in the vicinity of the interface with the negative electrode collector and containing a binding material having a Tg of 0° C. or less and a low binding property in the negative electrode mixture layer on the surface side and containing the binding materials at a high content on the negative electrode collector side and at a low content on the surface side.

What is claimed is:

1. A negative electrode plate for nonaqueous electrolyte secondary battery, comprising:
a negative electrode collector; and
a negative electrode mixture layer disposed on the negative electrode collector, wherein
the negative electrode mixture layer contains a negative active material, a first binding material having a glass transition temperature (Tg) of 10° C. to 60° C., and a second binding material having a glass transition temperature (Tg) of 0° C. or less;
a negative electrode mixture layer (a) is one half on the negative electrode collector side of the negative electrode mixture layer, and a negative electrode mixture layer (b) is the other half on the surface side of the negative electrode mixture layer when the negative electrode mixture layer is divided into two equal parts at the center in the thickness direction;
the negative electrode mixture layer (a) contains the first binding material;
the negative electrode mixture layer (b) contains the second binding material; and
A and B satisfy a relationship: 0.04≦B/(A+B)<0.5 where the A is a content of the first and second binding materials relative to the mass of the negative active material in the negative electrode mixture layer (a) and the B is a content of the first and second binding materials relative to the mass of the negative active material in the negative electrode mixture layer (b).

2. The negative electrode plate for nonaqueous electrolyte secondary battery according to claim 1, wherein
a negative electrode mixture layer (c) is one half on the negative electrode collector side of the negative electrode mixture layer (a), and a negative electrode mixture layer (d) is the other half of the negative electrode mixture layer (a) disposed between negative electrode mixture layer (c) and the negative electrode mixture layer (b) when the negative electrode mixture layer (a) is divided into two equal parts at the center in the thickness direction; and B, C and D satisfy a relationship: C>D>B where the C is content of the first and second binding materials relative to the mass of the negative active material in the negative electrode mixture layer (c) and the D is content of the first and second binding materials relative to the mass of the negative active material in the negative electrode mixture layer (d).

3. The negative electrode plate for nonaqueous electrolyte secondary battery according to claim 1, wherein
the first binding material and the second binding material are styrene butadiene rubbers having different glass transition temperatures (Tg).

4. A method of producing a negative electrode plate for nonaqueous electrolyte secondary battery, the method comprising:
forming a first application layer by applying an application composition containing a first binding material having a glass transition temperature (Tg) of 10° C. to 60° C. onto a surface of a negative electrode collector;
forming a first negative electrode mixture layer by drying the first application layer formed on the negative electrode collector at a temperature not higher than the glass transition temperature (Tg) of the first binding material;
forming a second application layer by applying a composition containing a negative active material and a second binding material having a glass transition temperature (Tg) of 0° C. or less onto the surface of the first negative electrode mixture layer; and
forming a negative electrode mixture layer by drying the second application layer.
